(19) United States
(12) Patent Application Publication
(10) Pub. No.: US 2012/0166619 A1
(43) Pub. Date: Jun. 28, 2012

(54) LICENSING AND METERING OF VIRTUALIZED APPLICATIONS

(75) Inventors: Cread Wellington Mefford, JR., Malden, MA (US); Lidiane Pereira de Souza, Middleton, MA (US); Karri Alexion-Tiernan, Fall City, WA (US)

(73) Assignee: Microsoft Corporation, Redmond, WA (US)

(21) Appl. No.: 12/977,110

(22) Filed: Dec. 23, 2010

(51) Int. Cl. G06F 21/24; G06F 15/173

(52) U.S. Cl. 709/224; 726/27

(57) ABSTRACT

When a request is received to execute a virtualized application, a licensing/metering component determines whether a valid license exists for the requested application. If the licensing/metering component determines that a valid software license exists for the requested application, the application virtualization server component streams the virtualized application to a client device and permits the application to be executed. If the licensing/metering component determines that a valid software license does not exist for the requested application, the application virtualization server component prevents the virtualized application from being streamed to the client device. Once the virtualized application is streamed to the client device, the licensing/metering component monitors usage of the virtualized application.

### BACKGROUND

The distribution and execution of computer programs, which may be referred to herein as “applications”, is often controlled via software licenses. Software licenses define the conditions under which software may be utilized. For instance, a software license might specify the number of users that are authorized to use an application at any given time.

Enforcement of software licenses can be challenging in modern computer environments where applications are not always executed in a traditional fashion. For instance, when computer systems virtualize the execution of applications (“application virtualization”), verifying that an application has a valid software license and monitoring the use of the application can be difficult. One reason for this difficulty is that virtualized applications are often streamed to client computers and do not exist locally on the client computers in a traditional sense. As a result, conventional technologies for enforcing licenses and monitoring usage may be incompatible or inefficient when used with virtualized applications. Moreover, conventional protocols for use in exchanging data regarding software licenses and usage monitoring may also be inefficient.

It is with respect to these and other considerations that the disclosure made herein is presented.

### SUMMARY

Technologies are described herein for enforcing software licenses and monitoring the usage of virtualized applications. Through an implementation of the concepts and technologies presented herein, an application virtualization environment can be provided that is capable of software license enforcement and application usage monitoring. In embodiments, the Hypertext Transfer Protocol (HTTP) protocol is utilized to stream virtual applications from a server to a client as well as to exchange data regarding the validity of a software license and application usage data. In this manner, a virtualized application may be streamed to a client, validated, and monitored using one or more HTTP connections.

Embodiments disclosed herein are implemented in conjunction with an application virtualization environment. In particular, an application virtualization client component is configured to provide an environment for execution of a virtualized application. The application virtualization client component also provides functionality for encapsulating the virtualized application from an underlying operating system, other application programs, and system resources. The application virtualization client component might also provide functionality for loading portions of the virtualized application by streaming needed portions of the virtualized application from an application virtualization server component over an HTTP connection.

According to another aspect, when a virtualized application is launched, a licensing/metering component verifies that a valid software license exists for the virtualized application. If a valid software license exists, the licensing/metering component causes an application virtualization server component to stream the virtualized application to a client device. The licensing/metering component might also monitor usage of the virtualized application. If a valid software license does not exist for the virtualized application, the licensing/metering component prevents the server from streaming the virtualized application to the client device. A connection may be established using the HTTP protocol between the client device and the application virtualization server component. The connection may be utilized to exchange data regarding the licensing and usage of the virtualized application.

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a software and network architecture diagram showing one illustrative operating environment for the embodiments disclosed herein;

FIG. 2 is a flow diagram showing aspects of one illustrative process disclosed herein for licensing and metering virtualized applications, according to one embodiment presented herein; and

FIG. 3 is a computer architecture diagram showing an illustrative computer hardware and software architecture for a computing system capable of implementing the various embodiments presented herein.

### DETAILED DESCRIPTION

The following detailed description is directed to technologies for validating software licenses and metering the use of virtualized applications. As discussed briefly above, an application virtualization environment is provided that is configured to validate a software license associated with a virtualized application when the virtualized application is executed. The application virtualization environment is also configured monitor the use of the virtualized application using the licensing/metering component. Data regarding the software license and the usage of the virtualized application may be exchanged utilizing the HTTP protocol.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for licensing and metering of virtualized applications will be described.

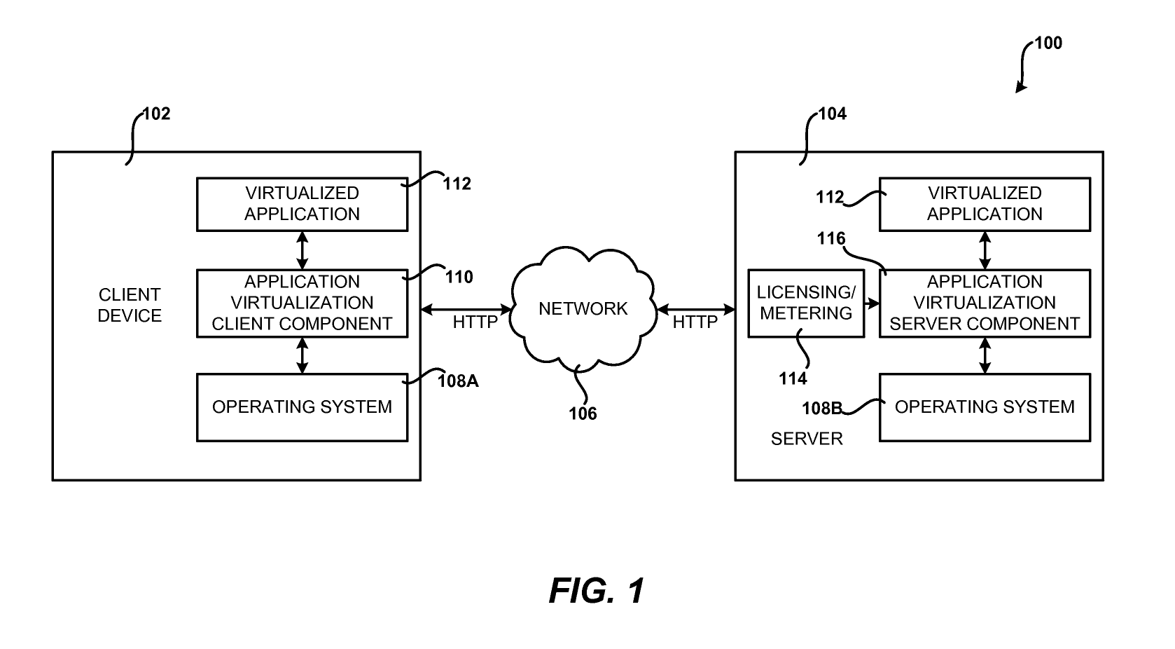

FIG. 1 is a software and network architecture diagram showing one illustrative operating environment 100 for the embodiments disclosed herein. The illustrative operating environment 100 shown in FIG. 1 includes a client device 102 configured to communicate with a server 104 by way of the network 106. The client device 102 is a computing device configured to execute an operating system 108A and an application virtualization client component 110. The client device 102 may be a standard desktop or laptop computer, a tablet computer, a smartphone or any other type of computing device capable of performing the operations presented herein for licensing and metering of virtualized applications. The client device 102 might also be a server computer configured to provide the functionality disclosed herein.

The server 104 is a computing system configured to execute an operating system 108B and the application virtualization server component 116. It should be appreciated that the server 104 may be an actual server computer configured to execute the application virtualization server component 110 or may comprise another type of computer system configured to perform the functionality described herein as being performed by the server 104.

The network 106 illustrated in FIG. 1 may comprise a wide area or local area network. For instance, the network 106 may be a corporate local area network, a wide area network such as the Internet, or a combination of multiple wide area and local area networks. It should be appreciated that while a single network 106 has been illustrated in FIG. 1, many other networks may be utilized. It should also be appreciated that while a single client device 102 and server 104 have been illustrated in FIG. 1, many such devices may be utilized by the embodiments disclosed herein.

As discussed briefly above, the client device 102 is configured to execute an application virtualization client component 110. The application virtualization client component 110 is a software component configured to provide an application virtualization environment. In this regard, the application virtualization client component 110 is configured to execute a virtualized application 112.

The application virtualization client component 110 provides functionality for encapsulating the execution of the virtualized application 112 from the operating system 108A. The application virtualization client component 110 might also provide functionality for encapsulating execution of the virtualized application 112 from other application programs and system resources of the client device 102. For instance, the application virtualization client component 110 might virtualize resources of the operating system 108A or the client device 102. When the virtualized application 112 attempts to access the physical resources, the application virtualization client component 110 presents a virtualized resource to the application 112. In this manner, the virtualized application 112 can be executed in a manner that does not impact the actual resources exposed by the operating system 108A or the client device 102.

According to other aspects, the application virtualization client component 110 also provides functionality for loading portions of the virtualized application 112 on-demand. In particular, the application virtualization client component 110 may operate in conjunction with the application virtualization server component 116 to stream needed portions of the virtualized application 112 from the server 104 to the client device 102. In this manner, the virtualized application 112 can be accessed at the client device 102 on-demand without having the virtualized application 112 fully installed at the client device 102.

Additional details regarding the various functions provided by the application virtualization client component 110 for encapsulating execution of the virtualized application 112 and for streaming the virtualized application 112 from the server 104 to the client device 102 can be found in U.S. Pat. No. 7,225,264 filed May 29, 2007 entitled “Systems and Methods for Delivering Content over a Computer Network,” U.S. Pat. No. 7,200,632 filed Apr. 3, 2007 entitled “Method and System for Serving Software Applications to Client Computers,” U.S. Pat. No. 7,451,451 filed Nov. 11, 2008 entitled “Operating System Abstraction and Protection Layer,” and U.S. Pat. No. 7,797,372 filed Sep. 14, 2010 entitled “Serving Software Applications from Servers for Client Computers,” each of which is incorporated herein in their entirety by reference.

The virtualized application 112 may be streamed from the application virtualization server component 116 to the application virtualization client component 110 using a transport protocol. For example, in one embodiment disclosed herein, the virtualized application is streamed from the server 104 to the client 102 using the HTTP protocol. Using the HTTP protocol to stream a virtualized application 112 from a server 104 to a client 102 may be more efficient and faster than using a typical streaming protocol, for example, the real time streaming protocol (RSTP).

According to one implementation, the application virtualization server component 116 is also configured to provide software license enforcement and metering functionality. For instance, a licensing/metering component 114 is provided in one embodiment that is configured to validate a software license associated with the virtualized application 112. If the software license can be validated, the licensing/metering component 114 permits the virtualized application 112 to be streamed to the client device 102. If the software license cannot be validated, the licensing/metering component 114 will not permit the virtualized application 112 to be streamed to the client device 102.

The licensing/metering component 114 may be configured in various ways to assist in the validation of a software license for the virtualized application 112. For example, the licensing/metering component 114 may validate a software license by comparing a serial number associated with the virtualized application 112 that are stored by or accessible to the licensing/metering component 114 with a serial number entered by the user of the client device 102 and received at the server 104. If the serial number entered by the user matches the serial number stored at or accessible to the licensing/metering component 114, the licensing/metering component 114 allows the application virtualization server component 116 to stream the requested virtualized application 112 to the application virtualization client component 110. If the serial number does not match, the virtualized application 112 will not be streamed.

The licensing/metering component 114 may also validate a software license by receiving and processing requests for authentication received from the virtualized application 112 executing on the client device 102. In this regard, many applications are configured to perform an authentication process by communicating with a local or remote server computer. Through an appropriate data exchange, the application can authenticate itself and begin execution.

In one embodiment, the licensing/metering component 114 is configured to receive and respond to requests for authentication from a virtualized application 112 executing on the client device 102. In this regard, the licensing/metering component 114 might expose one or more application programming interfaces (APIs) for receiving these calls. Various APIs might also be exposed by the licensing/metering component 114 to enable applications created by various manufacturers to make API calls to the licensing/metering component 114 for authentication.

In response to receiving a request for authentication through an exposed API, the licensing/metering component 114 might determine whether execution of the application 112 may be permitted. For instance, the licensing/metering component 114 might determine whether execution of the application 112 may be permitted based upon an examination of available licenses for the application 112. Other mechanisms might also be utilized.

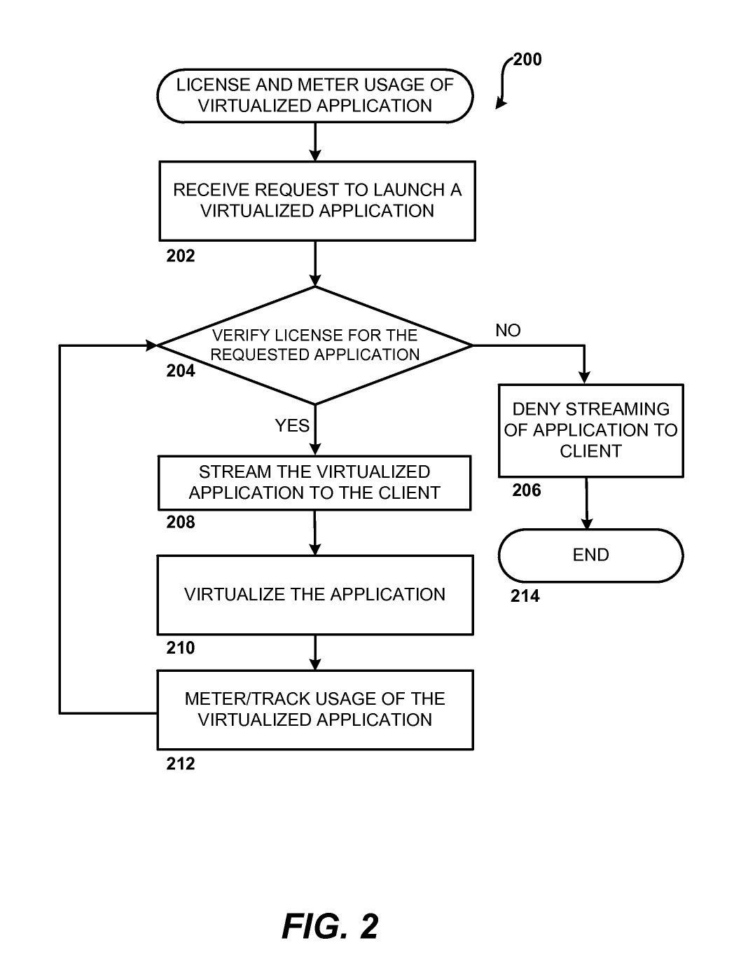

The licensing/metering component 114 might also monitor how the virtualized application 112 is used once the virtualized application 112 has been streamed to the client device 102. The licensing/metering component 114 may gather information related to how the virtualized application 112 is being used, user logins, how long the virtualized application 112 is used, when the virtualized application 112 is opened or closed by the user or the like. Additional details regarding the operation of the application virtualization client component 110, the licensing/metering component 114, the application virtualization server component 116, the client device 102, and the server 104 will be provided below with respect to FIG. 2.

It should be appreciated that although the licensing/metering component 114 has been illustrated as executing on the server 104, this component might also execute in part or whole on the client device. For instance, in one embodiment a licensing/metering client component executes on the client device 102 to performing all or a portion of the licensing and metering functions described above. Moreover, in other embodiments, the functions described herein as being performed by the licensing/metering component 114 may be integrated directly with the application virtualization server component 116, the application virtualization client component 110, or other programs executing on the server 104, the client 102, or another computer altogether. It should also be appreciate that data regarding licensing or usage of the virtualized application 112 may be transmitted between the client device 102 and the server 104 using the HTTP protocol. Other embodiments should be apparent to those skilled in the art.

FIG. 2 is a flow diagram showing a routine 200 that illustrates aspects of one illustrative process disclosed herein for license enforcement and metering of virtualized applications. It should be appreciated that the logical operations described herein with respect to FIG. 2 and the other FIGURES are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 200 begins at operation 202, where the application virtualization server component 116 determines whether a request has been received to launch a virtualized application 112. For instance, a user of the client device 102 may make a request to launch the application 112. If the application virtualization server component 116 determines that a request has been received to execute the virtualized application 112, the routine 200 proceeds from operation 202 to operation 204.

At operation 204, the licensing/metering component 114 determines whether a valid software license exists for the requested virtualized application 112. A software license may be invalid if the license is expired or does not exist. A license might also be invalid if the terms of the request exceed the terms of the license. For instance, a license may indicate that only a specified number of instances of an application can be executed concurrently. A software license might be considered invalid for other reasons as well.

As discussed above, the application virtualization server component 116 may stream the virtualized application 112 to the application virtualization client component 110 upon request by a user and software license validation. If the licensing/metering component 114 determines that a valid software license exists for the requested application 112, the routine 200 proceeds from operation 204 to operation 208. If the licensing/metering component 114 determines that a valid software license does not exist for the requested application 112, the routine 200 proceeds to operation 206, where the server 104 is prevented from streaming the virtualized application 112 to the client device 102. From operation 206, the routine 200 proceeds to operation 214, where it ends.

At operation 208, the application virtualization server component 116 streams all or a portion of the application 112 to the client device 102. As discussed above, the application 112 may be streamed to the client device over an HTTP connection. From operation 208, the routine 200 proceeds to operation 210 where the application virtualization client component 110 virtualizes the application 112. As described above, this may include encapsulating the virtualized application 112 from an underlying operating system, other application programs, and system resources.

From operation 210, the routine 200 proceeds to operation 212, where the licensing/metering component 114 monitors execution of the virtualized application 112 and generates information (which may be referred to herein as “usage data”) related to the execution and use of the virtualized application 112. The information that may be generated may be related to how the virtualized application 112 is used, how long the virtualized application 112, and the like.

From operation 212, the routine 200 proceeds to operation 204, where the license for the application 112 is re-verified at different synchronization times between the client device 102 and the server 104. Accordingly, the virtualized application 112 is continually monitored to determine whether usage of the virtualized application 112 should be revoked because the license is no longer valid and ensure that the virtualized application 112 is unpublished when the license is no longer valid. By verifying the license during execution of the application, the technologies disclosed herein may ensure that the software license is properly enforced even while the application 112 is executing.

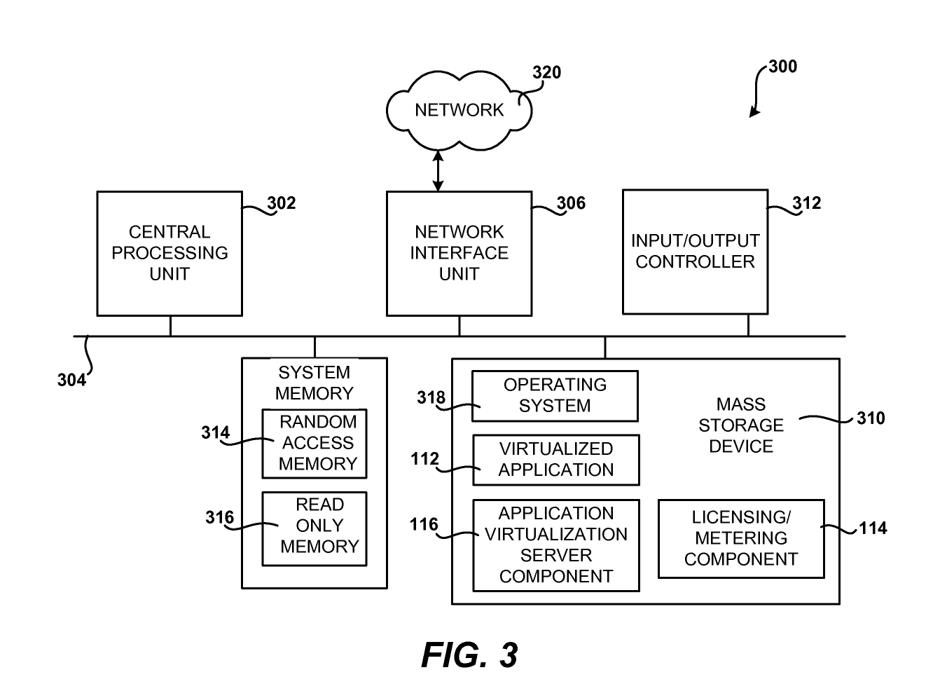

FIG. 3 is a computer architecture diagram showing an illustrative computer hardware and software architecture for a computing system capable of implementing the various embodiments presented herein. The computer architecture shown in FIG. 3 illustrates a conventional desktop, laptop computer, or server computer and may be utilized to execute the various software components described herein.

The computer architecture shown in FIG. 3 includes a central processing unit 302 (“CPU”), a system memory 308, including a random access memory 314 (“RAM”) and a read-only memory (“ROM”) 316, and a system bus 304 that couples the memory to the CPU 302. A basic input/output system (“BIOS”) containing the basic routines that help to transfer information between elements within the computer 300, such as during startup, is stored in the ROM 316. The computer 300 further includes a mass storage device 310 for storing an operating system 318, application programs, and other program modules, which will be described in greater detail below.

The mass storage device 310 is connected to the CPU 302 through a mass storage controller (not shown) connected to the bus 304. The mass storage device 310 and its associated computer-readable storage media provide non-volatile storage for the computer 300. Although the description of computer-readable media contained herein refers to a mass storage device, such as a hard disk or CD-ROM drive, it should be appreciated by those skilled in the art that computer-readable storage media can be any available computer storage media that can be accessed by the computer 300.

By way of example, and not limitation, computer-readable storage media may include volatile and non-volatile, removable and non-removable media implemented in any method or technology for storage of information such as computer-readable instructions, data structures, program modules or other data. For example, computer-readable storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other non-transitory medium which can be used to store the desired information and which can be accessed by the computer 300.

It should be appreciated that the computer-readable media disclosed herein also encompasses communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Computer-readable storage media does not encompass communication media.

According to various embodiments, the computer 300 may operate in a networked environment using logical connections to remote computers through a network such as the network 320. The computer 300 may connect to the network 320 through a network interface unit 306 connected to the bus 304. It should be appreciated that the network interface unit 306 may also be utilized to connect to other types of networks and remote computer systems. The computer 300 may also include an input/output controller 312 for receiving and processing input from a number of other devices, including a keyboard, mouse, or electronic stylus (not shown in FIG. 3). Similarly, an input/output controller may provide output to a display screen, a printer, or other type of output device (also not shown in FIG. 3).

As mentioned briefly above, a number of program modules and data files may be stored in the mass storage device 310 and RAM 314 of the computer 300, including an operating system 318 suitable for controlling the operation of a networked desktop, laptop, or server computer. The mass storage device 310 and RAM 314 may also store one or more program modules. In particular, the mass storage device 310 and the RAM 314 may store the virtualized application 112, the application virtualization server component 116, the licensing/metering component 114, and/or the other software components described above. The mass storage device 310 and RAM 314 may also store other program modules and data.

In general, software applications or modules may, when loaded into the CPU 302 and executed, transform the CPU 302 and the overall computer 300 from a general-purpose computing system into a special-purpose computing system customized to perform the functionality presented herein. The CPU 302 may be constructed from any number of transistors or other discrete circuit elements, which may individually or collectively assume any number of states. More specifically, the CPU 302 may operate as one or more finite-state machines, in response to executable instructions contained within the software or modules. These computer-executable instructions may transform the CPU 302 by specifying how the CPU 302 transitions between states, thereby physically transforming the transistors or other discrete hardware elements constituting the CPU 302.

Encoding the software or modules onto a mass storage device may also transform the physical structure of the mass storage device or associated computer readable storage media. The specific transformation of physical structure may depend on various factors, in different implementations of this description. Examples of such factors may include, but are not limited to: the technology used to implement the computer readable storage media, whether the computer readable storage media are characterized as primary or secondary storage, and the like. For example, if the computer readable storage media is implemented as semiconductor-based memory, the software or modules may transform the physical state of the semiconductor memory, when the software is encoded therein. For example, the software may transform the states of transistors, capacitors, or other discrete circuit elements constituting the semiconductor memory.

As another example, the computer readable storage media may be implemented using magnetic or optical technology. In such implementations, the software or modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

Based on the foregoing, it should be appreciated that technologies for license enforcement and metering of virtualized applications have been presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method comprising performing computer-implemented operations for:
receiving a request to launch a virtualized application via a Hypertext Transfer Protocol (HTTP) connection;
determining in response to the request whether the virtualized application has a valid software license; and
in response to determining that the virtualized application has a valid software license, streaming at least a portion of the virtualized application to a client device via the HTTP connection.

2. The computer-implemented method of claim 1, further comprising:
not streaming the virtualized application via the HTTP connection in response to determining that the virtualized application does not have a valid software license.

3. The computer-implemented method of claim 2, further comprising:
monitoring the execution of the virtualized application;
generating usage data based on the monitoring of the execution of the virtualized application that describes the usage of the virtualized application; and
transmitting the usage data to a server computer via the HTTP connection.

4. The computer-implemented method of claim 3, wherein the software license is not valid because the software license is expired or does not exist.

5. The computer-implemented method of claim 1 wherein the software license is not valid because a number of available software licenses for the virtualized application are exceeded.

6. The computer-implemented method of claim 1, wherein determining whether the virtualized application has a valid software license comprises determining whether a serial number provided by a client device matches a serial number associated with the software license.

7. The computer-implemented method of claim 1, wherein determining whether the application has a valid software license comprises contacting a licensing/metering component executing on a server to determine whether the virtualized application has a valid software license.

8. The computer-implemented method of claim 7, wherein the licensing/metering component exposes an application programming interface (API) to verify that a valid software license exists for the virtualized application.

9. The computer-implemented method of claim 1, wherein streaming the virtualized application to the client device via the HTTP connection occurs on-demand.

10. The computer-implemented method of claim 1, wherein determining whether the virtualized application has a valid software license occurs prior to streaming the virtualized application.

11. A computer-readable storage medium having computer-executable instructions stored thereupon which, when executed by a computer, cause the computer to:
receive a request to launch a virtualized application via a Hypertext Transfer Protocol (HTTP) connection;
in response to receiving the request, to determine whether the virtualized application has a valid software license; and to
stream at least a portion of the virtualized application to a client device via the HTTP connection in response to determining that the virtualized application has a valid software license.

12. The computer-readable storage medium of claim 11, having further computer-executable instructions stored thereon which, when executed by the computer, cause the computer to monitor execution of the virtualized application to generate usage data describing the execution of the virtualized application and to transmit the usage data to a server via the HTTP connection.

13. The computer-readable storage medium of claim 12, having further computer-executable instructions stored thereon which, when executed by the computer, cause the computer to not stream the virtualized application when the software license for the application is not valid.

14. The computer-readable storage medium of claim 13, wherein the software license is not valid because the software license is expired or does not exist.

15. The computer-readable storage medium of claim 11, having further computer-executable instructions stored thereon which, when executed by the computer, cause the computer to not stream the virtualized application when a number of available software licenses for the application are exceeded.

16. The computer-readable storage medium of claim 11, wherein determining whether the requested application has a valid software license comprises comparing a provided serial number to a serial number associated with the software license.

17. The computer-readable storage medium of claim 11, wherein determining whether the requested application has a valid software license comprises using an authentication process for license validation.

18. The computer-readable storage medium of claim 17, wherein the authentication process utilizes an application program interface (API) to verify that a valid software license exists for the application.

19. The computer-readable storage medium of claim 11, wherein determining whether the requested application has a valid software license occurs prior to launching the virtualized application.

20. A computer-readable storage medium having computer-executable instructions stored thereupon which, when executed by a computer, cause the computer to:
receive a request to launch a virtualized application via a Hypertext Transfer Protocol (HTTP) connection;
determine whether the virtualized application has a valid software license prior to launching the virtualized application;
stream at least a portion of the virtualized application to a client device via the HTTP connection in response to determining that the virtualized application has a valid software license;
monitor execution of the virtualized application to generate usage data describing the use of the virtualized application; and
transmitting the usage date to a server computer via the HTTP connection.
